(19) United States
(12) Patent Application Publication
(10) Pub. No.: US 2008/0041608 A1
(43) Pub. Date: Feb. 21, 2008

(54) Cable Duct

(76) Inventor: Franz-Josef Thiel, Worms (DE)

Correspondence Address: BARLEY SNYDER, LLC, 1000 WESTLAKES DRIVE, SUITE 275, BERWYN, PA, 19312, US

(21) Appl. No.: 11/842,616

(22) Filed: Aug. 21, 2007

(30) Foreign Application Priority Data
Aug. 21, 2006 (DE) 102006039165.9

(51) Int. Cl. H02G 3/04; B60R 16/02

(52) U.S. Cl. 174/68.3

(57) ABSTRACT

A cable duct for carrying a cable, the cable duct comprising a cable enclosure, a cover for closing the cable enclosure, the cover comprising a retainer and configured to project toward the cable enclosure to hold the cable in the cable duct when the cover is in a closed position is disclosed.

### CROSS-REFERENCE TO RELATED APPLICATION DATA

This application claims the benefit of the filing date under 35 U.S.C. §119(a)-(d) of foreign patent application DE 10 2006 039 165.9 of Aug. 21, 2006.

### FIELD OF THE INVENTION

The invention relates to a cable duct for carrying at least one cable or conductor.

### BACKGROUND

Cable ducts that carry a conductor bundle comprising a plurality of conductors or cables are known. The conventional cable duct is equipped on its top surface with a cover by means of which the cable duct can, at least sectionwise, be closed off in order to prevent the undesired falling out of the cable bundle. The cover is fastened to the cable duct e.g. pivotally. It may, however, also be push-fitted on the cable duct. To this end, the cable duct is usually equipped with appropriate introduction lugs. The size of the cable duct is generally predefined by its necessary intrinsic stability. This leads to a situation where conductor bundles, which are normally relatively small, are located in the cable duct at a great distance away from the cover.

Cable ducts of this kind have the disadvantage that the conductor bundle can move freely within the cable duct and, as a result, e.g. vibrations and rattling noises may occur. In addition, individual cables or conductors may, as a result of their freedom of movement within the cable duct, become entangled with one another or even be damaged due to movement within the cable duct.

### SUMMARY

The present invention relates to a cable duct for carrying a cable, the cable duct comprising a cable enclosure, a cover for closing the cable enclosure, the cover comprising a retainer and configured to project toward the cable enclosure to hold the cable in the cable duct when the cover is in a closed position is disclosed.

### BRIEF DESCRIPTION OF THE DRAWINGS

Embodiments of the invention are further described below with reference to the accompanying drawings, in which:

FIG. 1 is a schematic perspective view of a cable duct according to the invention with an opened cover;

FIG. 2 is a further schematic perspective view of the cable duct according to FIG. 1;

FIG. 3 is a schematic perspective view of the cable duct according to FIG. 1, wherein the cable duct is closed with the cover;

FIG. 4 is a side view of the closed cable duct according to FIG. 3;

FIG. 5 is a schematic side view in which the cover is pivoted from an open position into a closed position; and

FIG. 6 is a schematic view of a cable duct according to the invention in which a plurality of cable enclosures are closed with covers.

### DETAILED DESCRIPTION OF THE EMBODIMENT(S)

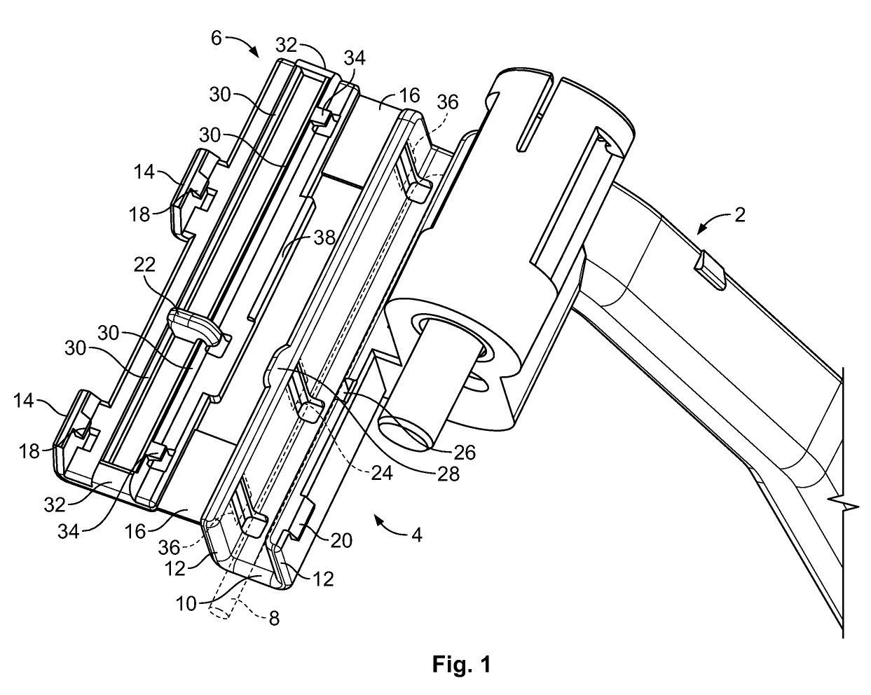

Below, the structure of a cable duct 2 according to the invention will first be explained with reference to FIGS. 1 to 4.

FIGS. 1 to 4 show a part of a cable duct 2. The cable duct 2 is here equipped with at least one cable enclosure 4, which is configured to be open toward one end and which can be closed with a cover 6. A cable 8 may be carried in the cable duct 2. The cable 8 comprises one or more conductors or cables. The cable duct 2 may be equipped with e.g. a cable enclosure 4 with a substantially U-shaped cross-section having a base 10 and two side walls 12. Disposed on one of the side walls 12 is the cover 6, which extends over at least part or over the entire length of the cable enclosure 4.

The cover 6 is provided with at least one closure element 14 in order to close the cable duct 2 in a manner such that no cable or cable 8 can unintentionally fall out of the cable duct 2.

The cover 6 is pivotally fastened to one of the two side walls 12 of the cable duct 2 by means of at least one hinge 16. The hinge 16, e.g. a film hinge, may be integrally formed, from the same material, on the cable duct 2 and/or the cover 6. This has the advantage that it can be produced simply and cost-effectively. The hinge 16 may, however, also be constructed as a separate component. In addition to a film hinge, a multiplicity of further hinge types are also conceivable, e.g. spring hinges, torque hinges or piano hinges. In addition, the hinge 16 may be produced from plastics material and/or metal. It is further possible to configure the cover 6 in a manner such that it can be push-fitted on the cable duct 2 or snap-fitted thereon (not shown).

The cable duct 2 and/or the cover 6 may be produced from plastic as an injection moulded component. They may, however, also be produced from other materials, e.g. sheet metal.

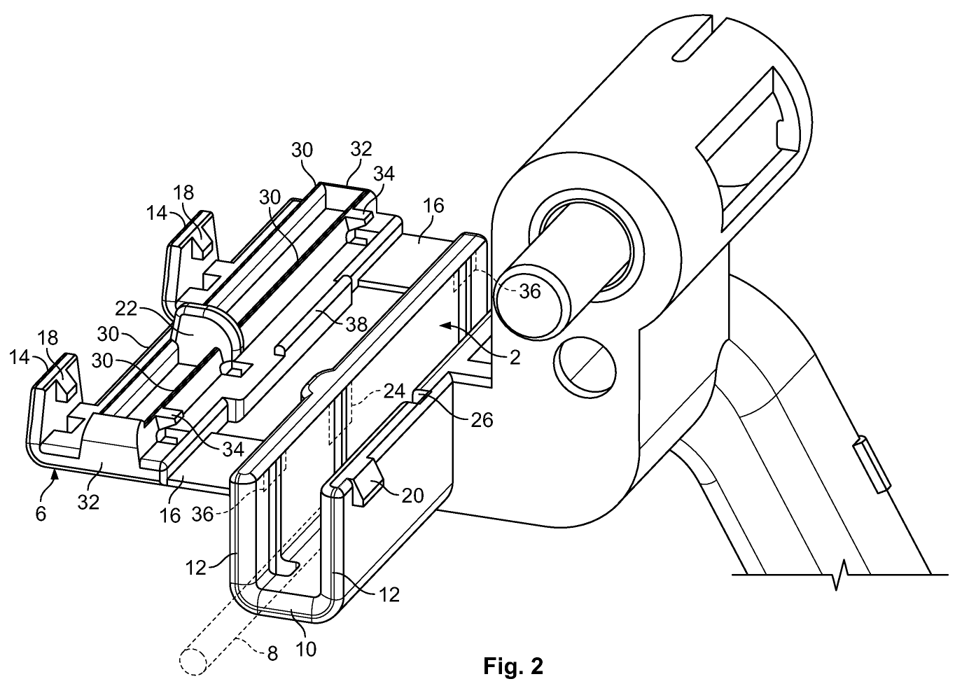

As shown in FIGS. 1 and 2, the closure elements 14 of the cover 6 are each equipped with a hook 18. The hook 18 may here hook into or under the side wall 12 located opposite the side wall 12 on which the cover 6 is fastened. To this end, this side wall 12 may be equipped with a tab 20 in which the hook 18 can be engaged. Alternatively or in addition, the side wall 12 may also be equipped with a depression (not shown) in which the hook 18 can hook or engage in order to hold the cover 6 reliably in a closed position.

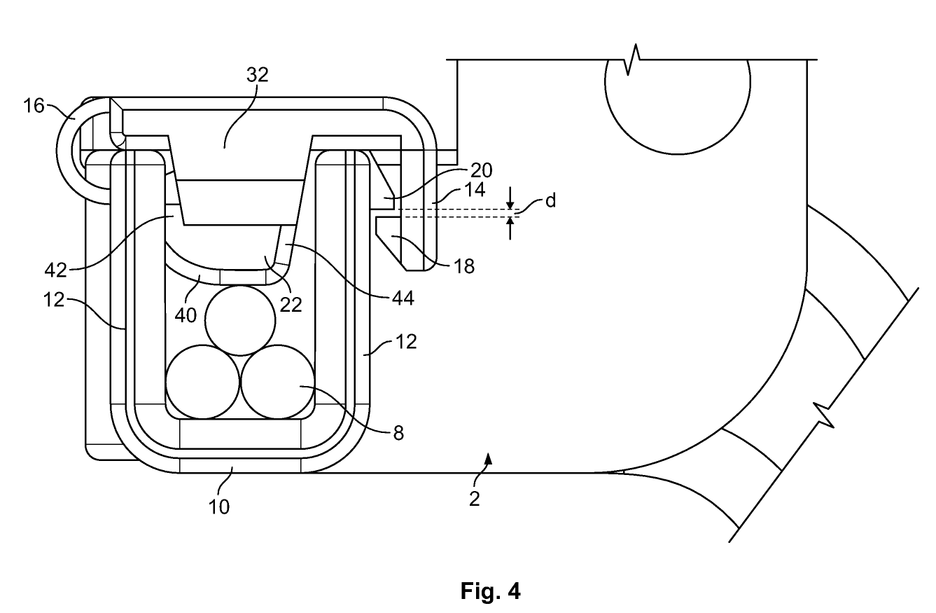

It is also shown in FIGS. 1 and 2 that the cover 6 is equipped with a retainer 22 in the form of a projection. The retainer 22 projects from the cover 6 in its closed state sufficiently far into the cable duct 2, and is of a suitable length, for it to be able to hold the inserted cables 8 or a conductor bundle securely in the cable duct 2, as shown in FIG. 4 by way of example. Normally, up to eight cables are carried in a cable duct 2. However, just one single cable or more than eight cables may also be provided. The retainer 22 is formed in a manner such that it reliably prevents any trapping of the cables or conductors against the side wall 12, and thereby avoids any damage thereto.

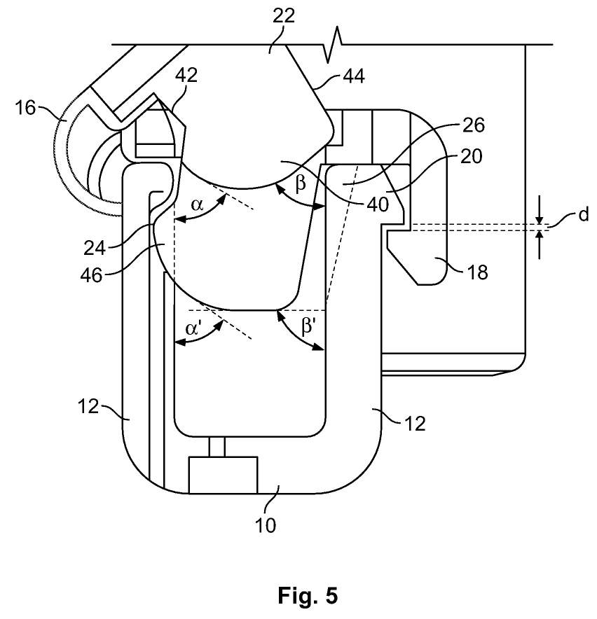

The retainer 22 may project into the cable duct 2 far enough to hold the cable 8 securely in the cable duct 2 or press them into the cable duct 2 without damaging them. The form of the retainer 22 is described in greater detail below with reference to FIGS. 4 and 5.

As shown in FIGS. 1 to 3, the retainer 22 is disposed offset relative to the particular closure element 14, e.g. centrally between the two closure elements 14. This has the advantage that the retainer 22 can flex more readily in order to compensate differences in tolerances or dimensional accuracy in respect of the inserted cables or the cable enclosure 4. It is however, also perfectly possible for the retainer 22 to be disposed on or in the vicinity of a closure element 14.

As shown in FIG. 4, between the catch of the closure element 14, or specifically its hook 18, and the tab 20 or the depression (not shown) of the side wall 12 into which the closure element 14 hooks, a clearance or space d is provided, ensuring the engagement security of the cover 6. When the cover 6 is moved into a closed position and the retainer 22 is pivoted into the cable duct 2, the retainer 22 can come into contact with the cable 8 and flex onto or away from them in order in this manner to compensate tolerance and dimensional fluctuations.

FIG. 4 shows, by way of example, three cables 8, which are carried in the cable duct 2 in a manner such that the retainer 22 just comes into contact with the cables 8, wherein the clearance d applies. In the event that, for example, instead of the cables 8 shown, cables 8 with a greater diameter are carried in the cable duct 2, the cover 6 can flex accordingly. As a result, the cover 6 can easily compensate the greater diameters of the cables 8 without squeezing them together excessively. In addition, the cover 6 and/or the hinge 16 and/or the retainer 22 may be, at least partially, flexibly constructed. As a result, it is possible for the cover and/or the hinge 16 and/or the retainer 22 additionally to yield somewhat when the retainer 22 comes into contact with the cables 8.

As already described above, the retainer 22 is disposed offset relative to the closure elements 14, e.g. centrally between the closure elements 14. As a result, the cover 6 can itself e.g. arch upwards slightly more and, as a result, additionally facilitate the flexing where large tolerance differences are present and, in addition, exert a certain pressure on the cables 8.

As indicated with broken lines in FIGS. 1 and 2, the side wall 12 to which the cover 6 is fastened may additionally be equipped with a depression or aperture 24. This depression or aperture 24 serves to allow the entry of a section of the retainer 22 when the cover 6 is pivoted into the closed position. This is also shown in FIG. 5.

The depression or aperture 24 is also equipped with a clearance (not shown) to enable the movement of the retainer 22 within this region.

As further shown in FIGS. 1 and 2, a depression 26 or aperture (not shown) may be provided on the side wall 12 located opposite the side wall 12 to which the cover 6 is fastened. This depression 26 or aperture has the advantage that the length of the retainer 22 is not restricted by the distance between the side walls 12. Even long retainers 22 can thereby be easily pivoted into the cable duct 2 without scraping against or even resting on the side wall 12.

Moreover, the side wall 12 may be additionally strengthened by means of a stiffener 28, optionally in the region into which the retainer 22 pivots into the cable duct 2.

In addition, by means of at least one rib 30 or, as shown, by means of four ribs 30, the cover 6 may optionally be strengthened and/or additionally positioned. Optionally provided at a longitudinal end of the ribs 30 may be, in addition, an endpiece 32, which is shaped or chamfered and/or rounded in a manner such that the cables or conductors 8 exiting from the cable duct 2, which are e.g. bent upwards towards the cover 6, do not encounter any sharp edges by which they could be damaged. The same applies to the edges of the cable duct 2. These edges may be of rounded construction.

According to FIGS. 1 and 2, the ribs 30 of the cover 6 may optionally be additionally provided with at least one holder 34. When the cover 6 is pivoted downwards, the holder 34 can engage in or hook into the side wall 12 to which the cover 6 is fastened, in order to provide additional retention for the cover 6. To this end, the side wall 12 is likewise equipped with a corresponding depression or aperture 36, into which the holder 34 can hook or engage. This depression or aperture 36 is indicated in FIG. 1 with a broken line. By contrast with the depression or aperture 24 for the retainer 22, no corresponding clearance need be provided here to the extent that the retainer 22 is disposed offset relative to the holder 34.

The holder 34 has the advantage that the cover 6 will remain reliably coupled with the side wall 12, and thereby with the cable duct 2, even if the hinges 16 were to break off. A further advantage is that the holder 34 can provide additional centering of the cover 6 on the cable duct 2, so the cover 6 does not rest obliquely on the cable duct 2.

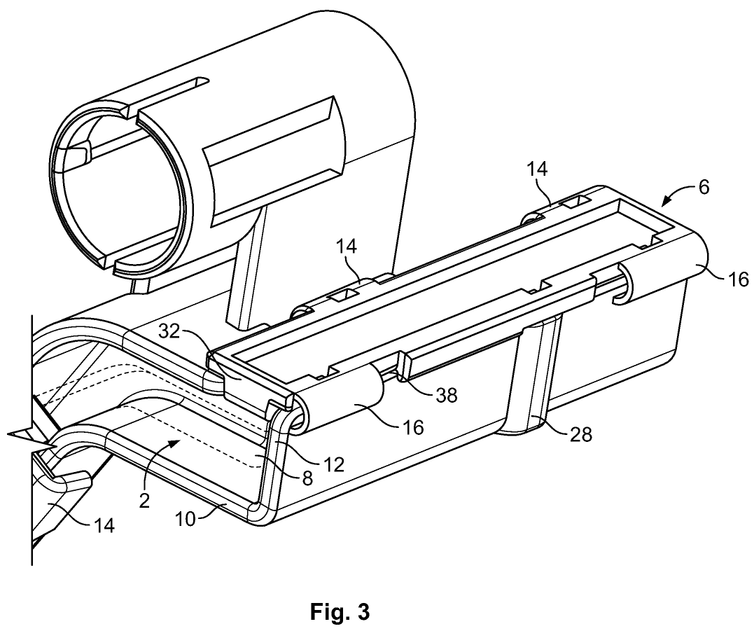

In one embodiment, the cover 6 may additionally be provided on at least one of its longitudinal sides with at least one projection or raised edge 38. The edge 38 stands raised from the cover 6 in a manner such that, in the closed position of the cover 6, the edge 38 bears on the corresponding side wall 12 in order to provide it with lateral support, as shown in FIG. 3. This has the advantage that the hinges 16 cannot be so easily broken off when forces are exerted on the cover 6 laterally. In addition, the cover 6 can obtain further alignment with the side wall 12 by means of the edge 38.

As already described above with reference to FIGS. 1 to 4, the retainer 22 is shaped in a manner such that it holds a multiplicity of cables 8 in the cable duct 2 and prevents any trapping and damaging of the cable 8.

When the cover 6 is pivoted downwards, a cable 8 that finds itself between the retainer 22 and the side wall 12 is pressed towards the base 10 of the cable duct 2 by the shape of the retainer 22. In this event, the cable 8 is not trapped against the side wall 12. Instead, it is pressed downwards towards the base 10 and away into the cable duct 2 by the shape of the retainer 22 and held there by the retainer 22. To this end, the retainer 22 is equipped with an appropriately shaped, rounded section, as shown in FIGS. 4 and 5.

FIGS. 4 and 5 show that the retainer 22 is equipped with a base section 40 and two sides, a first side 42 and a second side 44. First side 42 is equipped with a rounded bulge 46, which is introduced into the above-described aperture or depression 24 (FIGS. 1 and 2) of the side wall 12 when the retainer 22 is pivoted into the cable duct 2.

As shown in FIG. 5, the bulge 46 is shaped in a manner such that, when inserted into the cable duct 12, it forms a relatively large angle α, e.g. about 70°, with the side wall 12 of the cable duct 2. The illustration in FIG. 5 is not to scale. The base section 40 of the retainer 22, when inserted into the cable duct 2, forms e.g. an angle β of about 50° or more with the other side wall 12.

When the retainer 22 has been fully pivoted into the cable duct 2, as also shown in FIG. 5, the bulge 46 forms a smaller angle α′ with the side wall 12. This equals e.g. about 55°. The angle α′ is of a size such that, when the retainer 22 is pivoted in, a cable 8 cannot become trapped between the retainer 22 and the side wall 12, but instead is moved towards the base 10 of the cable duct 2. With the retainer 22 pivoted in, the base section 40 forms an angle β′ of e.g. about 90° with the side wall 12. The second side 44 dips into the depression 26 when the retainer 22 is pivoted, and thereby also prevents a cable 8 from being trapped. In the pivoted-in state, the distance between this second side 44 and the side wall 12 is such that, here too, no cables or conductors 8 can be trapped between them.

The above-mentioned values for the angles α, α′, β and β′ represent only examples at which the trapping of a cable 8 can be appropriately prevented. The present invention is, however, not restricted to these values for the angles.

The bulge 46 and the first side 42, the second side 44 and the base section 40 of the retainer 22 are rounded. Likewise, the edges of the retainer 22 are rounded so the cables 8 do not come into contact with sharp edges when the cables 8 are liable to be damaged as a result.

The provision of the retainer 22 with the rounded bulge 46 is advantageous because this reliably prevents a cable 8 from becoming trapped between the side wall 12 and the retainer 22 when the retainer 22 is pivoted into the cable duct 2.

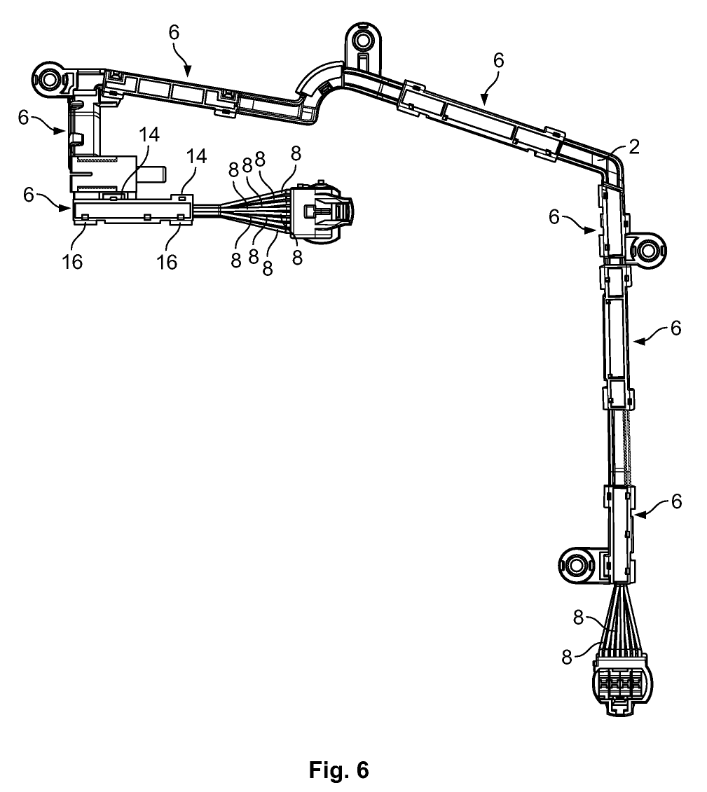

FIG. 6 shows a cable duct 2, as used e.g. in automotive engineering. The cable duct 2 is equipped with a plurality of cable enclosures 4, which are closed off with a cover 6 according to the invention.

The cable duct 2 is, however, not restricted to cable ducts 2 for automotive engineering purposes, and can be used in any sectors, including the most diverse, in which cable ducts are required to carry cables or conductors. In this regard, the cover 6 can be applied perfectly well not just to straight cable enclosures 4, but can also be matched to e.g. a curved shape of the cable enclosure 4. Instead of being fastened with hinges, the cover 6 may be e.g. push-fitted on the cable duct 2 in these regions.

What is claimed is:

1. A cable duct for carrying a cable, the cable duct comprising:
a cable enclosure;
a cover for closing the cable enclosure, the cover comprising a retainer and configured to project toward the cable enclosure to hold the cable in the cable duct when the cover is in a closed position.

2. The cable duct according to claim 1, the retainer comprising:
a first side;
a second side; and
a base section;
wherein when the cover is in the closed position, the cable is prevented from being trapped between the retainer and a side wall of the cable enclosure.

3. The cable duct according to claim 1, the retainer comprising:
a rounded bulge configured to prevent trapping of the cable between the retainer and a side wall of the cable duct as the retainer is introduced into the cable duct.

4. The cable duct according to claim 3, wherein an aperture for receiving the bulge is provided on the side wall.

5. The cable duct according to claim 3, wherein the cover is fastened to the side wall and wherein the side wall is comprises a stiffener on the sidewall

6. The cable duct according to claim 1, wherein the cover is pivotally fastened to the cable enclosure with a film hinge.

7. The cable duct according to claim 6, wherein at least one of the cover, the hinge, and the retainer is flexible and flexes against the cable when the cover is in a closed position.

8. The cable duct according to claim 1, wherein the cover comprises a closure element having a hook for engaging a tab on a side wall of the cable enclosure.

9. The cable duct according to claim 8, wherein a clearance is provided between the hook and the tab when the cover is in a closed position

10. The cable duct according to claim 4, wherein a clearance is provided between the retainer and the aperture.

11. The cable duct according to claim 8, wherein the retainer is disposed offset relative to the closure element.

12. The cable duct according to claim 1, wherein the cover comprises a rib along a longitudinal direction.

13. The cable duct according to claim 12, wherein a holder for engaging the side wall is provided on the rib to hold the cover in the closed position and wherein an aperture is provided on a side wall of the cable enclosure for allowing engagement of the holder with the aperture.

14. The cable duct according to claim 1, wherein the cover comprises an endpiece at each longitudinal end of the cover and wherein the endpieces have a rounded contour.

15. The cable duct according to claim 1, wherein the cover comprises an endpiece at a longitudinal end of the cover and wherein the endpiece has a rounded contour.

16. The cable duct according to claim 15, wherein the cover comprises an edge that bears on a side wall of the cable enclosure when the cover is in a closed position.

17. The cable duct according to claim 2, wherein the cover comprises an edge that bears on the side wall when the cover is in a closed position.

18. The cable duct according to claim 1, wherein the cover and the cable enclosure are joined by a hinge and wherein the hinge is formed integral to the cover.

19. The cable duct according to claim 1, wherein the cover and the cable enclosure are joined by a hinge and wherein the hinge is formed integral to the cable enclosure

20. The cable duct according to claim 1, wherein the cover and the cable enclosure are joined by a hinge and wherein the hinge is formed integral to both the cable enclosure and the cover.
